(19) United States
(12) Patent Application Publication
(10) Pub. No.: US 2013/0155947 A1
(43) Pub. Date: Jun. 20, 2013

(54) DATA COLLECTION PIGGYBACK PROTOCOL

(71) Applicant: James C. Curlander, Bellevue, WA (US)

(72) Inventor: James C. Curlander, Bellevue, WA (US)

(73) Assignee: MICROSOFT CORPORATION, Redmond, WA (US)

(21) Appl. No.: 13/332,341

(22) Filed: Dec. 20, 2011

(51) Int. Cl. H04W 4/00

(52) U.S. Cl. 370/328

(57) ABSTRACT

Data from collecting devices may be transmitted to a destination by piggybacking the data on a mobile device. In one example, when a mobile device comes within communication range of a data-collecting device, the data-collecting device, which may lack direct Internet connectivity, may upload data to the mobile device to be carried to a destination. The mobile device may store the data received from the collecting device. When the mobile device enters a state of Internet connectivity, the mobile device may use the Internet to upload the data that is carrying to a destination. In this way, collecting devices can transmit data to Internet locations without maintaining a direct, live connection to the Internet.

### BACKGROUND

There are many applications in which a device could collect data so that the data can be aggregated and analyzed later. Traffic sensors, weather sensors, pollution sensors, etc., are examples of such devices. A problem with such devices, however, is getting the data to the point of aggregation. In some cases, such a device is equipped with the hardware and software to allow the device to connect to the cellular system, thereby allowing the device to upload its data as if the device were a cell phone.

However, implementing connectivity to the cellular system can be expensive—in some cases, prohibitively so. Connecting a device to the cellular system generally includes the cost of the hardware and software components to allow the device to communicate with a cell tower, and also includes the cost of an agreement with a wireless carrier. If the function performed by the device justifies the cost, then the device may be equipped to communicate on the cellular system. However, in many cases there is a reason to allow a device to collect and upload data, but the cost of connecting the device to the cellular system cannot be justified.

### SUMMARY

A collecting device may collect and upload data by piggybacking that data onto the transmissions of other devices. When a collecting device has data to transmit, the collecting device may send out signals advertising the fact that it has data to transmit. These signals may be sent in ways that can be received by typical smart phones, tablets, laptops, or other mobile devices. For example, the signals can be sent by Bluetooth, infrared, WiFi, or in any other appropriate way. If a mobile device receives the advertisement and determines that it can carry data for the collecting device, then the mobile device notifies the collecting device of its availability to carry packets of data. The collecting device then transmits the data packets to the mobile device. The mobile device may continue to receive packets if it has capacity to store them. The collecting device may transmit all of its packets to one mobile device, or may divide the packets among plural mobile devices, depending on the mobile devices' available capacity.

When a mobile device that has received packets from a collecting device enters a state of network connectivity, the mobile device may transmit the packets that it has received from the collecting device to a specified destination. The packets themselves may specify their destination, or there may be a protocol that defines a central waypoint for packets received from collecting devices. The mobile device may use any type of network connectivity to transmit the packets that it received from the collecting device—e.g., WiFi, mobile broadband, or any other communication technology.

In one example, the collecting devices are stationary devices that collect traffic data, weather data, or air quality data. However, a collecting device could collect any type of data, and a collection device may be stationary or non-stationary.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example scenario in which collecting device may transmit data to mobile devices.

FIG. 2 is a block diagram of an example mobile device and its communication connections.

FIG. 3 is a flow diagram of an example process in which a collecting device may collect data and upload the data to a mobile device.

FIG. 4 is a flow diagram of an example process that a mobile device may perform in order to carry packets from a collecting device to a destination.

FIG. 5 is a block diagram of example components that may be used in connection with implementations of the subject matter described herein.

### DETAILED DESCRIPTION

There are many situations in which a device could collect data to be transmitted somewhere else. However, in order for a device to transmit data, it generally has to be connected to the communications infrastructure. Making such a connection involves either creating a wired connection to the Internet, or equipping the device with a connection to the cellular network to allow the data to be transmitted via Short Message Service (SMS) or mobile broadband. In many cases, such connections are prohibitively expensive. Many devices are in “field” locations (e.g., traffic sensors, weather sensors, air quality sensors, etc.), where they cannot feasibly be wired to data networks. If the value of the data justifies connecting the device to a cellular network, then the device may be equipped with the hardware and software to allow such a connection, as well as maintaining an agreement with a wireless carrier to allow the data to be transmitted over the connection.

However, there are various situations in which the data that could be collected and transmitted by a device has some value, but not enough value to justify the expense of making a connection to the cellular system. In some such cases, the data may be collected by manual upload (e.g., a person periodically visits the device and collects the data on a portable flash drive). However, manual collection of data also involves some expense, so—in cases where the data is of some value, but not sufficient value to justify its transport by existing mechanisms, the collection and transmission of the data is foregone entirely.

The subject matter described herein provides an efficient and inexpensive way to transport data from devices that collect data. Data that is collected by a device may be uploaded to mobile devices that happen to move into the vicinity of the collecting devices. Data that is uploaded to a mobile device may then be stored by the mobile device, until the mobile device enters a state of data connectivity. When the mobile device does enter such a state, the mobile device may upload the data to a location on the Internet. In this way, collecting devices (e.g., stationary devices that collect traffic data, weather data, air pollution data, etc.) can “piggyback” their transmission of data on the presumed, eventual network connectivity of existing mobile devices.

In order to allow collecting devices to transmit data in this way, a collecting device may equipped with hardware that allows the collecting device to communicate with passing mobile devices. For example, the collecting device may have a Bluetooth radio, an infrared transmitter and receiver, a WiFi transmitter and receiver, or any other mechanism that would allow the collecting device to communicate data with a passing mobile device. Typical mobile devices that can communicate in this way may include wireless telephones, music players, handheld gaming devices, tablet computers, laptops, etc. (The owners of these devices have an interest in privacy and in having their machines used in accordance with their permission. Therefore, appropriate permission may be obtained from the mobile device's owner before the mobile device would communicate with the collecting device.)

The collecting device may also be equipped with a memory to store collected data, a processor to execute instructions, and software that the collecting device may use to create packets of data and to advertise the presence of those packets to passing mobile devices. When a collecting device has packets to transmit, it may use its communications capability to advertise the presence of those packets. A mobile device within range of the collecting device may respond to the advertisement by signaling its willingness to receive packets from the collecting device. The collecting device may then transmit, to the mobile device, as many packets as the mobile device is able or willing to receive. If the collecting device still has packets to send after the mobile device indicates that it is unable or unwilling to receive more packets, the collecting device may wait for another mobile device to come into range, and may transmit these packets to another mobile device.

When the mobile device enters a state of Internet connectivity, the mobile device may then upload the packets that it received from the collecting device to an Internet destination. In one example, the packets themselves specify the destination to which they are to be sent. In another example, the mechanism by which the mobile device picks up packets from a collecting device and relays them to the Internet may be part of a known protocol, in which the destination for the packets is fixed by the protocol.

Packets collected by different mobile devices may be received by a common destination, thereby allowing the data contained in the packets to be reassembled. The reassembled data may then be analyzed, or any appropriate action may be taken with the data. For example, weather data could be collected and analyzed to build weather models, or traffic data could be analyzed to build traffic models.

In one example, the collecting device may transmit copies of the same packets to different devices. Since it is possible that a mobile device to which data packets are uploaded will not enter a state of network connectivity, it is possible for the packets carried by that mobile device to be lost. Therefore, transmitting the same packets to different mobile devices increases the chance that the packets will reach their destination. Duplicate packets can be detected at the destination (e.g., by using packet sequence numbers attached to the packet), and any packet that reaches the destination more than once can be discarded.

The owners or operators of collecting devices may pay a fee to have their data transported in the manner described above. In one example, the network to which the mobile devices are connected could receive the fee, or a portion thereof, as a condition for allowing devices on their network to receive and upload packets from the collecting devices. In another example, the owners of the devices that carry the data could receive the fee, or a portion thereof. In another example, the ability to have mobile devices carry packets for collecting devices could simply be built into mobile devices in order to provide a generally-available service for which no fee is charged.

It is noted that various types of systems have been proposed in which data connectivity is established between a stationary node and a moving node. For example, some systems allow laptops or handheld computers to be used in moving vehicles where connectivity is intermittent, since the vehicle frequently spends time outside the range of any wireless router. However, such systems are different from, and not obvious in view of, systems that relay data from a collection device to a network destination. Moreover, systems have been proposed in which data ferries carry data from locations where live network connectivity exists, to locations where live network connectivity is not available. However, it is noted that the idea of piggybacking data onto mobile devices that exist for reasons other than carrying data to non-connected locations is different from, and is not obvious in view of, the idea of carrying data on purpose-built data ferries.

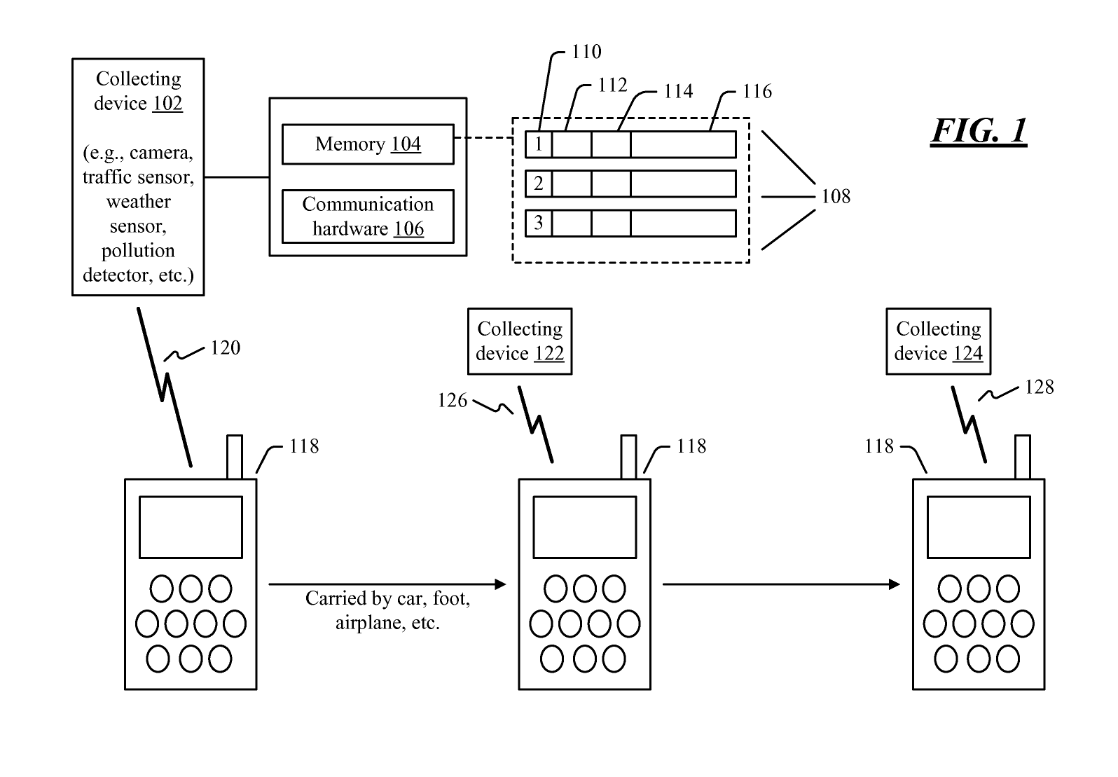

Turning now to the drawings, FIG. 1 shows an example scenario in which collecting devices may transmit data to mobile devices.

Collecting device 102 is a device that collects some type of data. For example, collecting device 102 may be a camera, a traffic sensor, a weather sensor, a pollution detector that detects air quality, a counting sensor, an industrial sensor, or any other type of data-collecting device. Mechanisms for collecting these and other types of data are generally known. For example, a weather sensor may include a thermometer, a humidistat, and a manometer. A traffic sensor may use an inductive loop embedded in a roadway to detect the presence of a vehicle. While a sensor of some type is one example of a collecting device, it is noted that the device with which data originates might not be a sensor. In another example, the device might be a robotic assembler on an assembly line, and the “mobile” device that carries the data might be the object being assembled, which carries data about the assembly process from robot to robot as it moves down the assembly line.

Collecting device 102 may have a memory 104 and communication hardware 106. Memory 104 is used to store data collecting by device 102. For example, if device 102 is a camera, then memory 104 may be used to store images captured by the camera. Or, if device 102 is a weather sensor, then memory 104 may be used to store temperatures, humidity levels, barometric pressures, etc. Communication hardware 106 may be used to communicate stored data to mobile devices such as wireless telephones, laptops, tablets, etc. Communications hardware 106 may comprise, for example, a Bluetooth radio, a WiFi radio, an infrared transmitter, or any other mechanism that allows communication with a mobile device.

The data that is collected by mobile devices may be divided into packets 108. Software may be used to divide the data into packets, as more particularly discussed below. Packets 108 may be atomic units that can be individually transmitted to mobile devices. Each packet may contain payload 116 (i.e., the underlying data that device 102 wants to transmit), and may also have fields containing a sequence number 110, billing information 112, and/or a destination 114. Sequence number 110 may be used to indicate the order of the packets, so that the underlying data may be reassembled from separate packets when the packets reach their destination. Billing information 112 may indicate the entity that is to be billed for the cost of transporting the packet, if a billing infrastructure is in place. Destination 114 may identify the location (e.g., the Uniform Resource Locator, or “URL”) to which the packet is to be delivered.

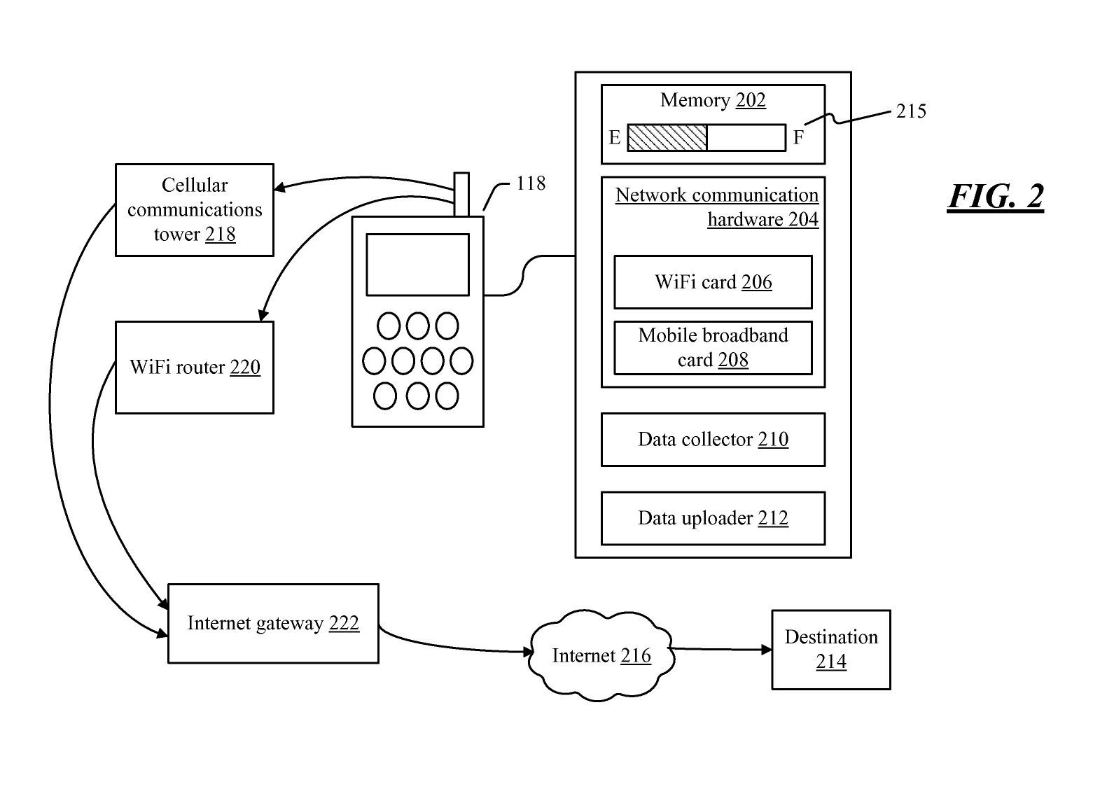

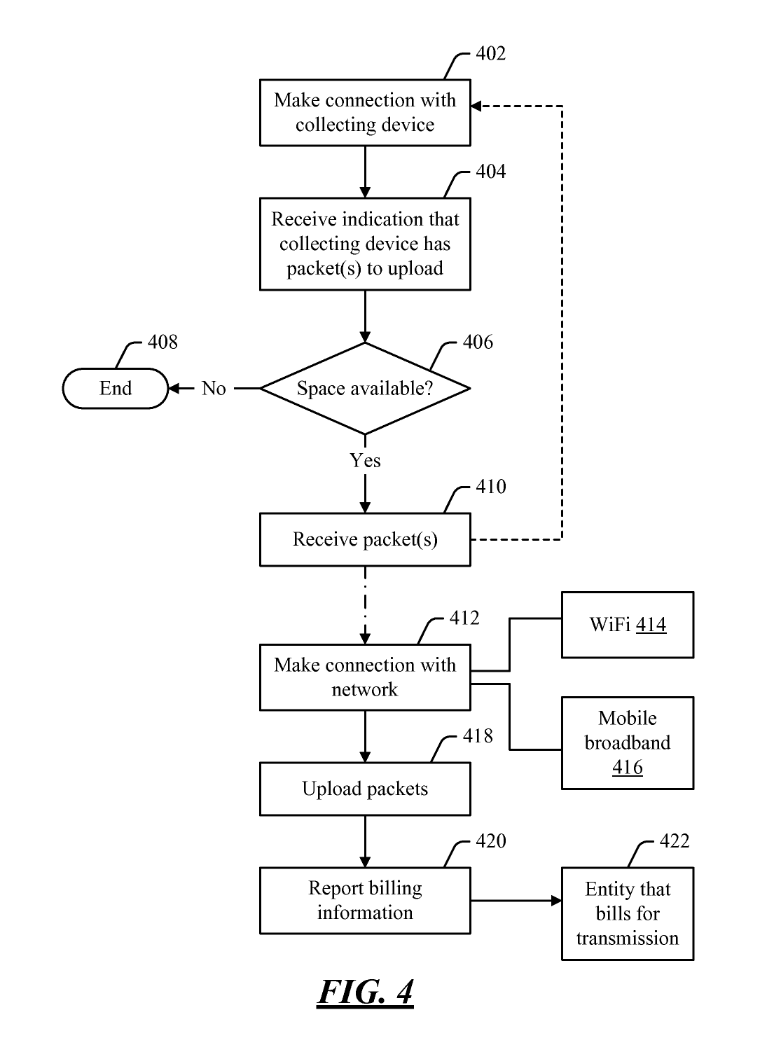

Mobile device 118 is a wireless telephone, laptop computer, tablet computer, handheld computer, handheld gaming device, or any other appropriate device that is generally movable. In one example, mobile device 118 is a kind of device that is typically carried by a person, although mobile device 118 could be mobile in the sense that it is permanently affixed to a vehicle. At some point, mobile device 118 comes into the communication range of collecting device 102, and is able to establish a communication link 120 with collecting device 102. For example, the communication link 120 may be established by mobile device 118's joining a Bluetooth piconet with collecting device 102, by establishing an ad hoc WiFi link with collecting device 102, or by some other mechanism. Mobile device 118 may receive, through communication link 120, collecting device 102's advertisement indicating that collecting device 102 has packets to transmit. If mobile device 118 has space to carry the packets, and is willing to do so, then mobile device 118 may indicate, through communication link 120, its availability and willingness to carry the packets. Collecting device 102 then uploads the packets to mobile device 118, which stores the packets. What mobile device 118 does with the packets that it has received is described in greater detail below, in connection with FIGS. 2 and 4.

Mobile device 118 is mobile in the sense that it may travel with a person and/or a vehicle—e.g., by being in a person's pocket as the person moves on foot, by car, by airplane, etc., or by being attached to a vehicle itself (e.g., as in the case of a wireless telephone or on-board computer that is installed in, or built into, a car). Thus, mobile device 118 may move into, and out of, the communication range of different collecting devices. In FIG. 1, there are a plurality of collecting devices 102, 122, and 124, which are located remotely from each other. Thus, mobile device 118 may come into communication range of collecting device 102, establish communication link 120 with that collecting device, may receive some packets, and then may leave collecting device 102's communication range. As mobile device 118 moves, it may then come into communication range of collecting device 122, may establish communication link 126 with collecting device 122, may receive some packets from collecting device 122, and then may leave the communication range of collecting device 122. Similarly, mobile device 118 may later come into communication range of collecting device 124, may establish communication link 128 with collecting device 124, may receive some packets from collecting device 124, and may then leave the communication range of collecting device 124. In this way, mobile device 118 may receive packets from various collecting devices by virtue of the fact that mobile device moves from one place to another.

It is noted that one aspect of mobile device 118 may be that it is not specifically built or deployed to carry data (in either direction) between the Internet and stationary devices that lack live Internet connections. In other words, mobile device 118 typically has some main function other than shuttling data between locations for which no live Internet link exists. In one example (e.g., in the case of a smart phone), the main function of the mobile device is to act as a person's mobile phone and mobile Internet device. In another example (e.g., in the case of a laptop computer or tablet), the main function of the mobile device is to act as a person's computer. In another example (e.g., in the case of a vehicle's on-board computer), the main function of the mobile device is to provide computing functions for a vehicle. In these cases, the mobile device's ability to pick up data from a collecting device and transport it to the Internet is incidental, and is not the mobile device's main function. Moreover, it is noted that the fact that the mobile device carries a particular item data from a collecting device may be due to the random chance that the mobile device happened to come into the vicinity of the collecting device. This random chance is in contradistinction to the situation in which a particular device—if not actually purpose-built to carry data—is selected to carry data based on some foreknowledge of where the device is going. For example, in some cases a device aboard a bus might be selected to carry data based on the idea that the bus's route is known to pass near the location of the anticipated consumer of the data. Mobile device 118, on the other hand, might carry a particular piece of data simply because of the random chance that it happened to pass near a collecting device, without there having been any advance selection of mobile device 118 to carry that data.

FIG. 2 shows an example of a mobile device and its communication connections. Mobile device 118 may have a memory 202, network communication hardware 204 (which may, for example, comprise a WiFi card 206 and/or a mobile broadband card 208), a data collector 210, and a data uploader 212.

Memory 202 may comprise a semiconductor memory (such as a volatile Random Access Memory (RAM) or a flash memory), a disk, or any other type of component that can store data. Memory 202 may be viewed as having a capacity that can run from empty to full, as indicated (item 215).

Memory 202 may be used to store packets received by mobile device 118 from a collecting device, and the memory's present level of utilization (e.g., it's current state on the empty-full scale) may be one limitation on mobile device 118's ability to carry data from collecting devices. (There may be other limitations—e.g., a mobile device may be unwilling to carry data, even if its memory is not yet full.)

Network communication hardware 204 may comprise an antenna, a network card, or any other appropriate type of hardware, which allows mobile device 118 to communicate with the Internet. For example, network communication hardware 204 may comprise a WiFi card 206, a mobile broadband card 208, an Ethernet port, or any other mechanism that allows mobile device 118 to communicate with the Internet. (It is noted that a WiFi card may be used both to participate in ad hoc WiFi communication with a collecting device, and also to participate in an 802.11 local area network with router that is connected to the Internet.)

Data collector 210 may comprise software that negotiates the receipt of data packets from collecting devices. For example, data collector 210 may contain the software to recognize a collecting device's advertisement of the fact that the collecting device has packets to transmit. Moreover, data collector 210 may contain software that determines whether mobile device 118 can carry data, and how much data it can carry. Moreover, data collector 210 may contain software that communicates with a collecting device in order to advise the collecting device of mobile device 118's availability (or lack of availability) to carry data.

Data uploader 212 may comprise software that causes the packets to be uploaded to a destination 214, when mobile device 118 enters a state of Internet connectivity. Data uploader 212 may detect when mobile device 118 has entered such a state, and may cause the packets received from a collecting device to be uploaded in response to its detection that mobile device 118 has entered a state of Internet connectivity.

Mobile device 118 may communicate with the Internet 216 in various ways. In one example, mobile device 118 uses mobile broadband, by communicating with a cellular communications tower 218. In another example, mobile device 118 uses WiFi to communicate with a WiFi router 220. Either cellular communication tower 218 or WiFi router 220 may be connected to internet gateway 222, which, in turn, may be connected to the Internet 216.

Regardless of the mechanism though which mobile device 118 communicates with the Internet, when a state of Internet connectivity has been achieved, mobile device 118 uses the Internet 216 to upload, to destination 214, packets that mobile device 118 has received from collecting device(s), and that it has stored in memory 202. As noted above, destination 214 may be specified in the packets themselves (e.g., in the form of a URL contained in a field of a packet). Or, as another example, destination 214 may be known to the components that participate in the transit of packets from collecting devices to destination 214—e.g., the identity of destination 214 may be hardcoded into data collector 210 and/or data uploader 212.

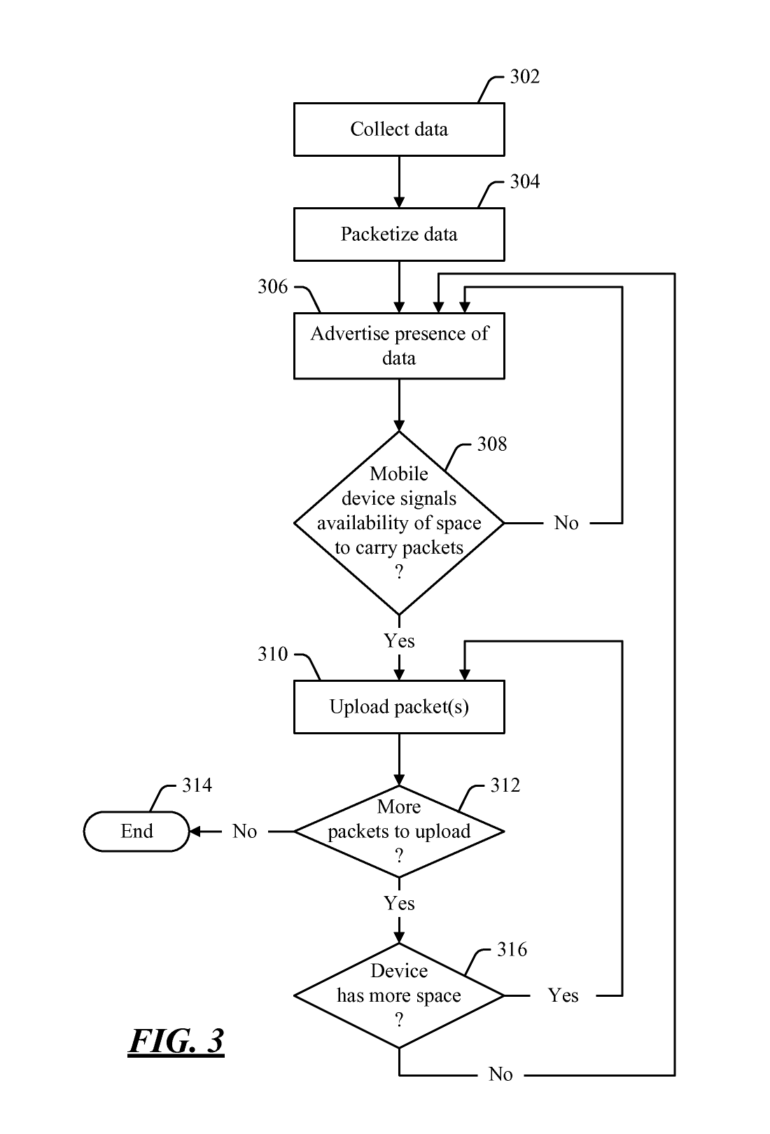

FIG. 3 shows an example process in which a collecting device may collect data and upload the data to a mobile device. Before turning to a description of FIG. 3, it is noted that the flow diagrams contained herein (both in FIG. 3 and in FIG. 4) are described, by way of example, with reference to components shown in FIGS. 1 and 2, although these processes may be carried out in any system and are not limited to the scenarios shown in FIGS. 1 and 2. Additionally, each of the flow diagrams in FIGS. 3 and 4 shows an example in which stages of a process are carried out in a particular order, as indicated by the lines connecting the blocks, but the various stages shown in these diagrams can be performed in any order, or in any combination or sub-combination.

At 302, a collecting device collects data. As described above, the nature of the collection process depends on the nature of the data being collected. If the data is images, the collecting the data may involve taking a photograph with a digital camera and storing the image. If the data is weather data, then collecting the data may involve taking periodic temperature, humidity, and barometric readings. If the data is traffic data, then collecting the data may involve detecting the presence of vehicles with an inductive loop embedded in a roadway, and recording the time and frequency at which vehicles ride over the inductive loop.

Regardless of the manner in which the data is collected, and regardless of the nature of the data, at 304 the data may be packetized. Data may be divided into packets of fixed or variable size. Each packet may, optionally, contain a sequence number, billing information, and/or a destination.

At 306, the collecting device may advertise the presence of packets to transmit. The collecting device may do this, for example, by using a Bluetooth or WiFi connection to send out signals indicating the availability of packets.

At 308, it is determined whether a mobile device has signaled the availability of space to carry packets. If no such signal has been received, then the process loops back to 306 in order to continue to advertise the availability of packets. The lack of a signal indicating a mobile device's availability to carry packets may take various forms. In one example, a mobile device actually receives and responds to the collecting device's advertisements, where the response affirmatively indicates that the mobile device is unable or unwilling to carry packets. In another example, the lack of a signal is simply the absence of any response from a mobile device. Such an absence may arise either because a mobile device received the advertisement and chooses not to respond, or because there was no mobile device within communication range to receive the advertisement.

If it is determined at 308 that a mobile device is available to carry packets, then the process continues to 310, where the collecting device uploads one or more packets to the mobile device. At 312, it is determined whether the collecting device has more packets to upload. If the collecting device has no more packets to upload, then the process ends at 314. If the collecting device does have more packets to upload, then it is determined, at 316, whether the mobile device has space to carry more packets. For example, the collecting device might ask the mobile device if it can continue uploading, and it might be assumed that no more uploading is possible unless the mobile device affirmatively indicates that there is space available. (It is possible that the mobile device travels outside of communication range during the uploading process. By waiting for an affirmative response from the mobile device before uploading any more packets, the collecting device may avoid uploading packets to a device that turns out to be unavailable for further uploading.)

If it is determined at 316 that the mobile device has space to carry more packets, then the process loops back to 310 to continue uploading packets to the mobile device. If it is determined at 316 that the mobile device does not have space to carry more packets, then the collecting device ceases uploading packets to the mobile device. The process then returns to 306, so that the collecting device can advertise the continued availability of packets.

FIG. 4 shows an example process that a mobile device may perform in order to carry packets from a collecting device to a destination. At 402, a mobile device may make a connection with a collecting device. As described above, this connection may be via Bluetooth, WiFi, or any other appropriate mechanism. At 404, the mobile device receives an indication that the collecting device has packets to upload. This indication may be the advertisement broadcast by the collecting device, as described above. At 406, the mobile device may determine whether it has space available to carry packets. As noted above, a mobile device might find that it does not have space available either because its memory is full (device is unable to carry packets), or because the mobile device has memory available that it does not want to use to carry packets (device is unwilling to carry packets). (In one example, the mobile device might learn from the collecting device how much the collecting device is willing to pay to have the packets transmitted, and might decline if the price is not high enough.) If the mobile device is unable and/or unwilling to carry packets, then the process may end at 408. (While the collecting device and mobile device are in communication with each other, the mobile device may notify the collecting device that it will not carry more packets.) If the device will carry packets (as determined at 406), then the mobile device may receive packets from the collecting device (at 410). As described above in connection with FIG. 3, during the process of receiving packets from the collecting device, the mobile device and the collecting device might engage in ongoing communication to determine that the mobile device is still within communication range, and still has space available to carry packets. Moreover, as indicated by the dotted line looping from 410 to 402, the mobile device may continue to make connections with other collecting devices, and may continue to receive packets from those device (e.g., if the mobile device moves out of the communication range of one collecting device and into the range of another collecting device).

At some point in time after the packets have been received by the mobile device (and, in many cases, after the mobile device and the collecting device have lost communication with each other), the mobile device may make a connection with a network, such as the Internet (at 412). The connection may be made in any appropriate manner, such as via WiFi 414 or mobile broadband 416. When connectivity has been established, at 418 the mobile device may upload packets to their destination via the network.

As noted above, in some cases packets may be carried for free. However, in other cases, there may be a billing infrastructure associated with the carrying of packets. If such a billing infrastructure is in place, then at 420 the mobile device may report billing information for the packets to the entity 422 that is to be billed for transmission. For example, the billing information contained in a packet may specify that a particular company (e.g., ABC Corporation, which might be the owner or operator of a collecting device) is to be billed for transmission of the packets, and might specify the amount that is to be billed. In this case, the mobile device might report the billing information to a network carrier (e.g., the mobile broadband carrier that the mobile device used to transmit the packets), in which case entity 422 is the network carrier. It is noted that it is possible for there to be a billing infrastructure that does not involve the mobile device's reporting billing information. For example, the destination to which the packets are sent could report billing information when the packets arrive, without involving the mobile device.

It is noted that, when the packets reach their destination, the data that was carried in those packets may be reassembled from the packets. In one example, sequence numbers in the packets allow the destination to determine whether there are any missing or duplicate packets, and allow the destination to reassemble the data contained in those packets in the appropriate order. The destination (or some further location to which the data might be sent) can perform analysis on the data—e.g., weather analysis, traffic analysis, image analysis, air quality analysis, or any other type of analysis depending on the type of data contained in the received packets.

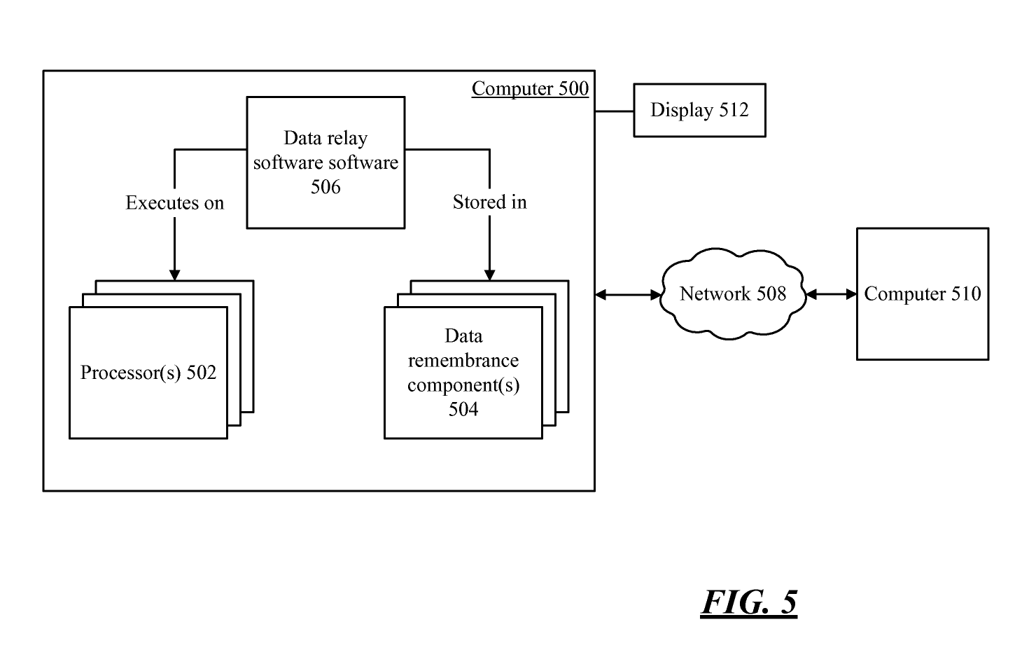

FIG. 5 shows an example environment in which aspects of the subject matter described herein may be deployed.

Computer 500 includes one or more processors 502 and one or more data remembrance components 504. Processor(s) 502 are typically microprocessors, such as those found in a personal desktop or laptop computer, a server, a handheld computer, or another kind of computing device. Data remembrance component(s) 504 are components that are capable of storing data for either the short or long term. Examples of data remembrance component(s) 504 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 500 may comprise, or be associated with, display 512, which may be a cathode ray tube (CRT) monitor, a liquid crystal display (LCD) monitor, or any other type of monitor.

Software may be stored in the data remembrance component(s) 504, and may execute on the one or more processor(s) 502. An example of such software is data relay software 506, which may implement some or all of the functionality described above in connection with FIGS. 1-4, although any type of software could be used. Software 506 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 5, although the subject matter described herein is not limited to this example.

The subject matter described herein can be implemented as software that is stored in one or more of the data remembrance component(s) 504 and that executes on one or more of the processor(s) 502. As another example, the subject matter can be implemented as instructions that are stored on one or more computer-readable media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable media, regardless of whether all of the instructions happen to be on the same medium. The term “computer-readable media” does not include signals per se; nor does it include information that exists solely as a propagating signal. It will be understood that, if the claims herein refer to media that carry information solely in the form of a propagating signal, and not in any type of durable storage, such claims will use the terms “transitory” or “ephemeral” (e.g., “transitory computer-readable media”, or “ephemeral computer-readable media”). Unless a claim explicitly describes the media as “transitory” or “ephemeral,” such claim shall not be understood to describe information that exists solely as a propagating signal or solely as a signal per se. Additionally, it is noted that “hardware media” or “tangible media” include devices such as RAMs, ROMs, flash memories, and disks that exist in physical, tangible form; such “hardware media” or “tangible media” are not signals per se. Moreover, “storage media” are media that store information. The term “storage” is used to denote the durable retention of data. For the purpose of the subject matter herein, information that exists only in the form of propagating signals is not considered to be “durably” retained. Therefore, “storage media” include disks, RAMs, ROMs, etc., but does not include information that exists only in the form of a propagating signal because such information is not “stored.”

Additionally, any acts described herein (whether or not shown in a diagram) may be performed by a processor (e.g., one or more of processors 502) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 500 may be communicatively connected to one or more other devices through network 508. Computer 510, which may be similar in structure to computer 500, is an example of a device that can be connected to computer 500, although other types of devices may also be so connected.

It is noted that, in the description and claims herein, items that are described as being “distinct” from each other are not the same instance of that item. For example, language that refers to a first device that is “distinct” from a second device indicates that the first device and the second device are two separate devices. The two devices may be separate devices (and, therefore, distinct) even if the two separate devices are identical to each other.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-readable medium comprising executable instructions transmit data, the executable instructions, when executed by a computer, causing the computer to perform acts comprising:
collecting data at a first device;
dividing said data into a plurality of packets;
advertising, via a communication link, that said first device has packets to transmit;
receiving, from a second device, an indication that said second device is available to carry some or all of said packets, said second device being a mobile device of a person, said second device performing a function for said person other than carrying data from said first device; and
uploading a first plurality of said packets to said second device to be transmitted to a destination that is distinct from said first device and from said second device.

2. The computer-readable medium of claim 1, said first device comprising a camera, said data comprising images captured by said camera.

3. The computer-readable medium of claim 1, said first device comprising a traffic sensor, said data comprising records of vehicles that are detected by said traffic sensor.

4. The computer-readable medium of claim 1, said first device being weather sensor, said data comprising weather data.

5. The computer-readable medium of claim 1, said first device being a pollution sensor, said data being air quality data.

6. The computer-readable medium of claim 1, each of said packets containing billing information that indicates an entity to which transmission of a packet is to be billed.

7. The computer-readable medium of claim 1, said acts further comprising:
uploading ones of said plurality of packets, other than said first plurality of packets, to said second device;
determining that said second device has indicated that said second device is unavailable to receive additional packets or has not responded to a communication from said first device; and
ceasing to upload packets to said second device.

8. The computer-readable medium of claim 1, said acts further comprising:
receiving, from a third device that is distinct from said second device, an indication that said third device is available to carry some or all of said plurality of packets; and
transmitting duplicates of said first plurality of packets to said third device.

9. The computer-readable medium of claim 1, said first plurality of said packets being uploaded to said second device with an instruction to transmit said first plurality of said packets to said destination.

10. The computer-readable medium of claim 1, said first plurality of packets being uploaded to said second device under a protocol under which said second device transmits packets that it receives to said destination.

11. A method of carrying data between a collecting device and a destination, the method comprising:
using a processor to perform acts comprising:
receiving, from said collecting device, and indication that said collecting device has packets to upload to a mobile device on which the method is performed, said mobile device performing a function for a person other than carrying data from said collecting device;
determining that space is available on said mobile device to carry data;
receiving a packet from said collecting device;
after said mobile device leaves a communication range of said collecting device and is no longer able to communicate with said collecting device, making a connection with a network; and
uploading said packet to said network to be transported to said destination.

12. The method of claim 11, said acts further comprising:
while said mobile device is communicating with said collecting device, determining not to carry additional packets from said collecting device, other than said packet, even though said mobile device has space available to store said additional packets.

13. The method of claim 11, said packet comprising billing information that identifies an first entity that pays for transmission of said packet, said acts further comprising:
reporting said billing information to a second entity that bills said first entity for transmission of said packet.

14. The method of claim 11, said mobile device being a wireless telephone, laptop computer, or tablet computer of said person.

15. The method of claim 11, said collecting device being a stationary device.

16. A collecting device comprising:
a memory;
a processor;
a sensor that collects data; and
a component that is stored in said memory, that executes on said processor, that divides said data into a plurality of packets, that stores said packets in said memory, that advertises via a communication link that said collecting device has packets to transmit, that receives, from a first mobile device of a person, an indication that said first mobile device is available to carry some or all of said packets, said first mobile device performing a function for said person other than carrying data from said collecting device, that uploads a first plurality of said packets to said first mobile device to be transmitted to a destination that is distinct from said collecting device and from said first mobile device.

17. The collecting device of claim 16, said collecting device comprising a camera, a traffic sensor, a weather sensor, or a pollution sensor.

18. The collecting device of claim 16, said component uploading ones of said plurality of packets, other than said first plurality of packets, to said first mobile device, said component determining that said first mobile device has indicated that said first device is unavailable to receive additional packets or has not responded to a communication from said collecting device, said component ceasing to upload packets to said first mobile device.

19. The collecting device of claim 16, said component receiving, from a second mobile device that is distinct from said first mobile device, an indication that said second mobile device is available to carry some or all of said plurality of packets, said component transmitting duplicates of said first plurality of packets to said second mobile device.

20. The collecting device of claim 16, each of said packets containing billing information that indicates an entity to which transmission of a packet is to be billed.
